(19) United States
(12) Patent Application Publication
(10) Pub. No.: US 2011/0072813 A1
(43) Pub. Date: Mar. 31, 2011

(54) Vehicle power generation system using exhaust gas

(76) Inventor: Boo-Sung Hwang, Seong-nam si (KR)

(21) Appl. No.: 12/798,985

(22) Filed: Apr. 15, 2010

(30) Foreign Application Priority Data
Apr. 21, 2009 (KR) 10-2009-0034530

(51) Int. Cl. B60K 6/20

(52) U.S. Cl. 60/597

(57) ABSTRACT

A vehicle power generation system using exhaust gas and includes a casing which is installed at a vehicle chassis and is formed of an inlet hole for inputting an exhaust gas and an outlet hole for discharging an exhaust gas, a turbine which is rotatably installed in the interior of the casing 10 and rotates by a pressure of the exhaust gas inputted into the inlet hole, a power generator which has a rotary shaft axially engaged to a shaft part of a turbine passing through a front side of the casing and a fixing bracket for fixing the power generator to the casing.

### TECHNICAL FIELD

The present disclosure relates to a vehicle power generation system using exhaust gas, and in particular to a vehicle power generation system using exhaust gas which generates electric power used for electrolysis as the system is used in a vehicle which uses a mixed gas of hydrogen and oxygen.

### BACKGROUND ART

A hydrogen-oxygen mixed gas generation apparatus is constituted to generate hydrogen and oxygen which are obtained as water is electrolysis-treated. The above apparatus generates a mixed gas of hydrogen and oxygen which is a non-pollution energy source by supplying water mixed with a small amount of electrolyte into an electrolysis tank equipped with a positive (+) electrode and a negative (−) electrode and applying a DC voltage thereto.

At this time, the hydrogen and oxygen are produced at a molecular ratio of 2:1, and hydrogen is produced in a form of bubble from the surface of the electrode (−), and oxygen is produced in a form of bubble from the surface of the electrode (+). The produced hydrogen and oxygen are mixed and become a mixed gas which is combustible. In casing of burning, any pollutants are not produced, so the hydrogen and oxygen gases are considered as an environment friendly energy source.

The applicant of the present disclosure has applied such hydrogen and oxygen mixed gas generation apparatus to a vehicle for thereby generating hydrogen and oxygen mixed gas and has researched to use the same as a fuel for driving an engine.

In order to generate a mixed gas of hydrogen and oxygen, it is needed to supply a couple of tens to hundreds of amperes to the electrodes (−) and (+). However, it seems difficult for the battery or generator installed in the vehicle to receive such currents.

### SUMMARY

A vehicle power generation system using exhaust gas, includes a casing which is installed at a vehicle chassis and is formed of an inlet hole for inputting an exhaust gas and an outlet hole for discharging an exhaust gas, a turbine which is rotatably installed in the interior of the casing and rotates by a pressure of the exhaust gas inputted into the inlet hole, a power generator which has a rotary shaft axially engaged to a shaft part of the turbine passing through a front side of the casing and a fixing bracket for fixing the power generator to the casing. The inlet hole is obliquely formed at a side portion of a front side of the casing, and the turbine includes a shaft part rotatably engaged to a bearing installed in the front and rear sides of the casing and a wing assembly rotated by a pressure of the exhaust gas inputted into the inlet hole, and the wing assembly includes a plurality of wing disks with a plurality of latch wings being opposite to the inlet hole, and the wing assembly is partitioned by a partition disk of a front side after the wing disks are stacked in the direction of the inlet hole, and a plurality of wing disks are stacked at the side of the inlet hole, and it is partitioned at the partition disk of the rear side, and a plurality of partition disks partition a plurality of wings stacked between the partition disk of the font side and the partition disk of the rear side, and in the stacked wing disks, the latch wings are arranged in a spiral shape, and holes formed in the partition disks are disposed between the latch wings in spiral shapes.

### BRIEF DESCRIPTION OF THE DRAWINGS

The present disclosure will become better understood with reference to the accompanying drawings which are given only by way of illustration and thus are not limitative of the present disclosure, wherein;

FIG. 1 is a perspective view of a vehicle power generation system using exhaust gas according to the present disclosure;

FIG. 2 is a front view of a wing disk belonging to a turbine of FIG. 1;

FIG. 3 is a front view of a partition disk belonging to a turbine of FIG. 1;

FIG. 4 is a view for explaining an inlet hole and a wing disk obliquely formed at a side portion of a casing in FIG. 1;

FIG. 5 is a side view of a turbine of FIG. 1.

### DETAILED DESCRIPTION

Accordingly, it is an object of the present disclosure to provide a vehicle power generation system using exhaust gas which is able to generate an electric energy using exhaust gas of a vehicle for the use of generating a mixed gas of hydrogen and oxygen.

To achieve these and other objects, there is provided a vehicle power generation system using exhaust gas which comprises a casing 10 which is installed at a vehicle chassis and is formed of an inlet hole 11 for inputting an exhaust gas and an outlet hole 12 for discharging an exhaust gas; a turbine 20 which is rotatably installed in the interior of the casing 10 and rotates by means of a pressure of the exhaust gas inputted into the inlet hole 11; a power generator 30 which has a rotatary shaft 31 axially engaged to a shaft part 21 of the turbine 20 passing through a front side of the casing 10; and a fixing bracket 40 for fixing the power generator 30 to the casing 10, wherein said inlet hole 11 is obliquely formed at a side portion of a front side of the casing 10, and said turbine 20 includes a shaft part 21 rotatably engaged to a bearing installed in the front and rear sides of the casing 10 and a wing assembly 22 rotated by a pressure of the exhaust gas inputted into the inlet hole 11, and said wing assembly 22 includes a plurality of wing disks 23 with a plurality of latch wings 23a being opposite to the inlet hole 11, and said wind assembly 22 is partitioned by a partition disk 24′ of a front side after the wing disks 23 are stacked in the direction of the inlet hole 11, and a plurality of wing disks 23 are stacked at the side of the inlet hole 12, and it is partitioned at the partition disk 24″ of the rear side, and a plurality of partition disks partition a plurality of wings stacked between the partition disk 24′ of the font side and the partition disk 24″ of the rear side, and in the stacked wing disks 23, said latch wings 23a are arranged in a spiral shape, and holes 24a and 24b formed in the partition disks 24, 24′ and 24″ are disposed between the latch wings 23a in spiral shapes.

There are further provided a plurality of radiation fins 15 formed on an outer surface of the casing 10 for externally radiating the heat generated by means of a high speed rotation of the turbine 20.

### EFFECTS

According to the vehicle electric power generation system using an exhaust system of the present disclosure, it is possible to generate electric power using exhaust gas without using an additional energy input since a turbine is rotated by means of an exhaust gas discharged from an engine, and the electric power is generated as the turbine drives the electric power generator.

In addition, since the turbine is formed of a plurality of wing disks equipped with latch wings being opposite to a plurality of inlet holes, so the turbine can be efficiently rotated by means of the exhaust gas, so that the electric power generator can be effectively driven for thereby generating a lot of electric power energy.

<Description of reference numerals of key elements in the drawings>

| | |
|---|---|
| 10: casing | 11: inlet hole |
| 12: outlet hole | 13: bracket |
| 15: radiation fin | 20: turbine |
| 21: shaft part | 22: wing assembly |
| 23: wing disk | 23a: latch wing |
| 24: partition disk | 24a, 24b: hole |
| 30: power generator | 40: fixing bracket |

The vehicle power generation system using exhaust gas according to the embodiments of the present disclosure will be described with reference to the accompanying drawings.

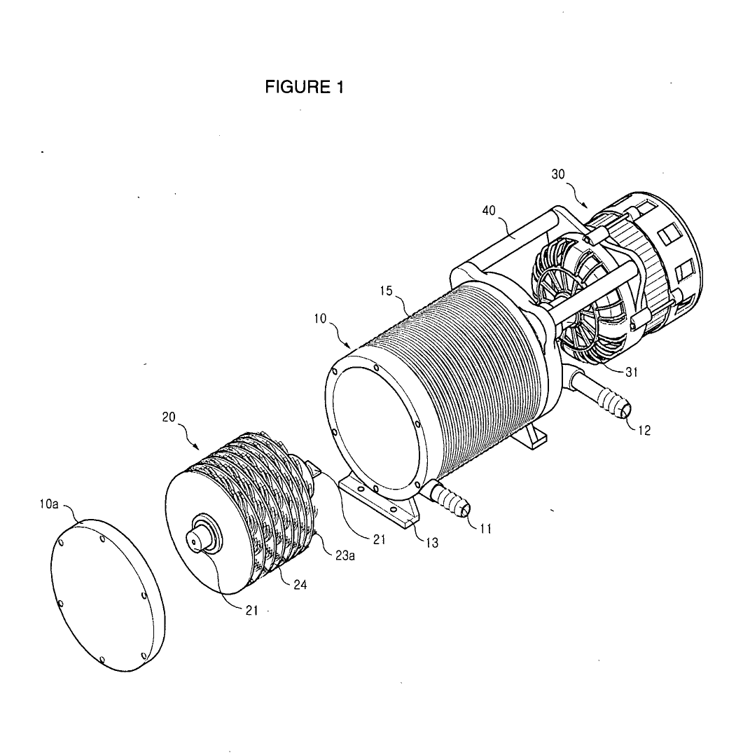

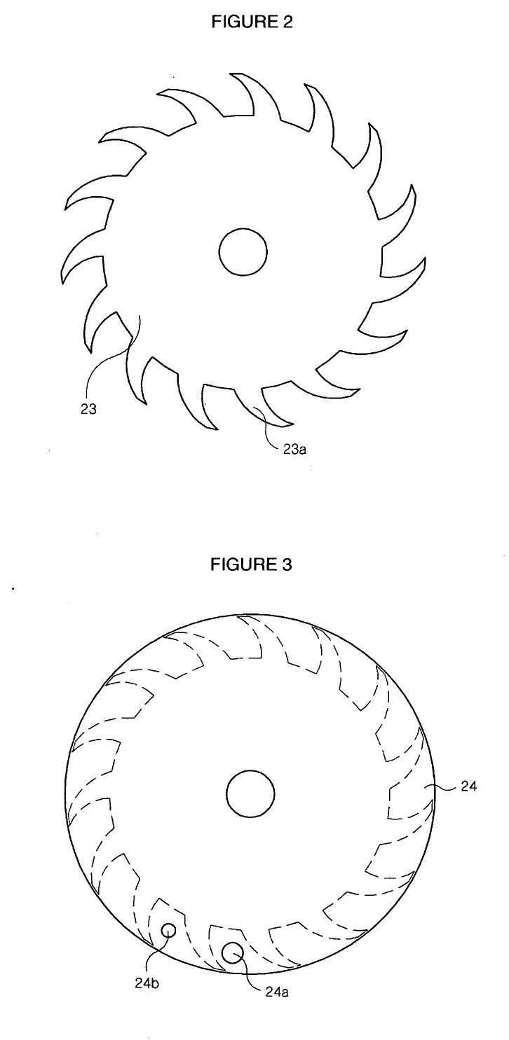

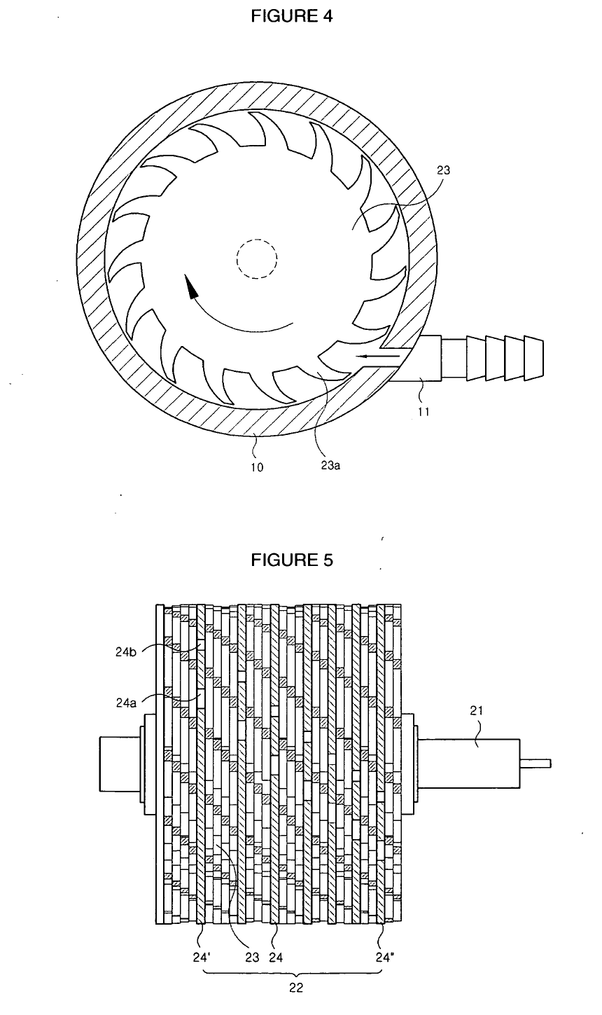

FIG. 1 is a perspective view of a vehicle power generation system using exhaust gas according to the present disclosure; FIG. 2 is a front view of a wing disk belonging to a turbine of FIG. 1; FIG. 3 is a front view of a partition disk belonging to a turbine of FIG. 1; FIG. 4 is a view for explaining an inlet hole and a wing disk obliquely formed at a side portion of a casing in FIG. 1; and FIG. 5 is a side view of a turbine of FIG. 1.

As shown therein, the vehicle power generation system using exhausting gas according to the present disclosure is installed on a chassis of a vehicle, which includes a casing 10 which is installed at a vehicle chassis and is formed of an inlet hole 11 for inputting an exhaust gas and an outlet hole 12 for discharging an exhaust gas; a turbine 20 which is rotatably installed in the interior of the casing 10 and rotates by means of a pressure of the exhaust gas inputted into the inlet hole 11; a power generator 30 which has a rotary shaft 31 axially engaged to a shaft part 21 of the turbine 20 passing through a front side of the casing 10; and a fixing bracket 40 for fixing the power generator 30 to the casing 10. The casing 10 is formed in a cylindrical shape which is fixed to a fixing part of a chassis of a vehicle. As shown in FIGS. 1 and 4, an inlet hole 11 is obliquely formed in a side portion of a front side of the casing 10 for inputting exhaust gas, and an outlet hole 12 is formed in a rear side of the casing 10 for discharging exhaust gas which has been used for rotating the turbine 20. Since the inlet hole 11 is obliquely formed, the exhaust gas inputted into the inlet hole 11 can effectively rotate the turbine 20. At this time, the inlet hole 11 is connected with a muffler which finally discharges exhaust gas, and the outlet hole 12 is connected with an additional pipe. Here, the inlet hole 11 might be connected with an exhaust manifold which exhausts exhaust from engine, and the outlet hole 12 may be connected with muffler. A bracket 13 is formed in the casing 10 and is engaged by means of a bolt and a nut to be fixed to a chassis of a vehicle. A plurality of radiation fins 15 are formed in an outer surface of the casing 10 for radiating heat which is generated by means of a high speed rotation of a turbine 20. Here, the radiation fins 15 can be integrally formed when forming the casing 10 in a cylindrical shape or can be separately formed and engaged to the casing 10. The turbine 20 includes a shaft part 21 rotatably engaged to a bearing (not shown) installed in the front and rear sides of the casing 10, and a wing assembly 22 which is engaged to the shaft part 21 and rotates by means of a pressure of the exhaust gas inputted into the inlet hole 11. The wing assembly 22 may be formed in various forms, and in the embodiment of the present invention, the wing assembly 22 includes a plurality of wing disks 23 with a plurality of latch wings 23a being opposite to the direction of the inlet hole 11, and a partition disk 24 which partitions the wing disk 23 and other wing disk 23′. As shown in FIG. 4, the front side of the latch 23a formed in the wing disk 23 is formed in a latch shape toward the inlet hole 11 for an easier rotation by means of an exhaust gas inputted into the inlet hole 11, and the rear side of the same is obliquely formed. In addition, a plurality of holes are formed in the partition disk 24 for discharging exhaust gas, and two holes 24a and 24b are preferably formed for easier description of the present invention. It is preferred that the holes 24a and 24b are obliquely formed when the thickness of the partition disk 24 is thick, and the inclination direction is toward the rotation direction of the turbine. The wing assembly is constituted in a structure that a plurality of wing disks 23 and a plurality of partition disks 24 are stacked in the shaft part 21. In the present embodiment, the wing assembly 22 is partitioned by means of the partition disk 24′ of the front side in which four wing disks 23 are stacked in the direction of the inlet hole 11, and two wing disks 23 are stacked in the side of the outlet hole 12 and are partitioned by the partition disk 24″ of the rear side, and a plurality of partition disks partition a plurality of wing disks stacked between the partition disk 24′ of the front side and the partition disk 24″ of the rear side partition. At this time, in the wing disks 23 stacked, the latch wings 23a are arranged in spiral shape, and the holes 24a and 24b formed in the partition disks 24, 24′ and 24″ partitioning the wing disks are arranged in spiral shapes between the latch wings 23a. With the structure of the turbine 20, the exhaust gas inputted into the inlet hole 11 pushes and rotates the latch wings 23a disposed as being opposite and in spiral shapes, and the exhaust gas is discharged through the outlet hole 12 through the holes 24a and 24b and the latch wing 23a formed in the partition disk 24 arranged in spiral shape. Namely, the exhaust gas pushes the latch wings 23a disposed in a spiral shape and passes through the other latch wings and the spiral holes 24a and 24b of the partition disk and pass through the outlet hole 12 for thereby effectively rotating the turbine 20. The rotating turbine 20 rotates the rotor of the power generator 20 for thereby producing a lot of electric power. The fixing bracket 40 integrally fixes the power generator 30 to the casing 10. With the above structure, the exhaust gas discharged from the engine is inputted into the interior of the casing 10 through the inlet holes 11 for thereby rotating the turbine 20, and the turbine 20 generates a lot of power as the turbine 20 drives the power generator 30. The generated electric power is supplied to the electrodes of the apparatus for generating a mixed gas of hydrogen and oxygen for the use of water electrolysis.

The embodiments of the present disclosure have been described with reference to the embodiments disclosed in the drawings, which are for illustrative purposes to aid in an understanding of the subject matter of the present disclosure, but are not intended, and may not be construed, to limit in any way the claims which follow hereafter. While specific terminology is employed for the sake of clarity in describing exemplary embodiments, the present disclosure is not intended to be limited to the specific terminology so selected, and it is to be understood that each specific element includes all technical equivalents which operate in a similar manner.

What is claimed is:

1. A vehicle power generation system using exhaust gas, comprising:
a casing 10 which is installed at a vehicle chassis and is formed of an inlet hole 11 for inputting an exhaust gas and an outlet hole 12 for discharging an exhaust gas;
a turbine 20 which is rotatably installed in the interior of the casing 10 and rotates by a pressure of the exhaust gas inputted into the inlet hole 11;
a power generator 30 which has a rotary shaft 31 axially engaged to a shaft part 21 of the turbine 20 passing through a front side of the casing 10; and
a fixing bracket 40 for fixing the power generator 30 to the casing 10,
wherein said inlet hole 11 is obliquely formed at a side portion of a front side of the casing 10, and said turbine 20 includes a shaft part 21 rotatably engaged to a bearing installed in the front and rear sides of the casing 10 and a wing assembly 22 rotated by a pressure of the exhaust gas inputted into the inlet hole 11, and said wing assembly 22 includes a plurality of wing disks 23 with a plurality of latch wings 23a being opposite to the inlet hole 11, and said wing assembly 22 is partitioned by a partition disk 24′ of a front side after the wing disks 23 are stacked in the direction of the inlet hole 11, and a plurality of wing disks 23 are stacked at the side of the inlet hole 12, and it is partitioned at the partition disk 24″ of the rear side, and a plurality of partition disks partition a plurality of wings stacked between the partition disk 24′ of the font side and the partition disk 24″ of the rear side, and in the stacked wing disks 23, said latch wings 23a are arranged in a spiral shape, and holes 24a and 24b formed in the partition disks 24, 24′ and 24″ are disposed between the latch wings 23a in spiral shapes.

2. The system of claim 1, further comprising a plurality of radiation fins 15 formed on an outer surface of the casing 10 for externally radiating the heat generated by a high speed rotation of the turbine 20.

3. A vehicle power generation system using exhaust gas, comprising:
a casing capable of being installed on a vehicle, the casing including an inlet hole for inputting an exhaust gas and an outlet hole for discharging the exhaust gas;
a turbine rotatably installed in an interior of the casing and rotatable by pressure of the exhaust gas inputted into the inlet hole, the turbine including a wing assembly and a shaft part passing through the casing; and
a power generator having a rotary shaft axially engaged to the shaft part of the turbine;
wherein said inlet hole is obliquely formed at a side portion of the casing, and wherein the shaft part of the turbine is rotatably engaged by bearings associated with the casing and the wing assembly is rotated by the pressure of the exhaust gas inputted into the inlet hole, and wherein said wing assembly includes a plurality of wing disks each having a plurality of latch wings, and wherein said wing assembly is partitioned by a partition disk associated with a first end of the casing after the wing disks are stacked in a direction of the inlet hole, and a partition disk associated with a second end of the casing after the wing disks are stacked in a direction of the outlet hole, and a plurality of partition disks partition a plurality of wing disks stacked between the partition disk associated with the first end of the casing and the partition disk associated with the second end of the casing, said latch wings being arranged in a spiral shape, and wherein holes are formed in the partition disks and are disposed between the latch wings in spiral shapes.

4. The system as recited in claim 3, further comprising a plurality of radiation fins provided on an outer surface of the casing for radiating heat generated by rotation of the turbine.

5. The system as recited in claim 3, further comprising a fixing bracket for fixing the power generator to the casing.

6. The system as recited in claim 3, wherein the inlet hole is obliquely formed at a side portion of the first end of the casing and the outlet hole is of provided at the second end of the casing.

7. The system as recited in claim 3, wherein the latch wings are provided opposite the inlet hole.
